(19) United States
(12) Patent Application Publication
(10) Pub. No.: US 2018/0018880 A1
(43) Pub. Date: Jan. 18, 2018

(54) SYSTEM AND METHOD FOR WORKSITE ROUTE MANAGEMENT

(71) Applicant: Caterpillar Inc., Peoria, IL (US)

(72) Inventors: Mariah Cherice Smith, Peoria, IL (US); Sanat Talmaki, Peoria, IL (US); Jason L. Smallenberger, Morton, IL (US)

(73) Assignee: Caterpillar Inc., Peoria, IL (US)

(21) Appl. No.: 15/207,851

(22) Filed: Jul. 12, 2016

(51) Int. Cl. G08G 1/00; G01C 21/34; G05D 1/02; G08G 1/127

(52) U.S. Cl. CPC G08G 1/20; G08G 1/127; G01C 21/3407; G05D 1/0297; G05D 2201/0202

(57) ABSTRACT

A haul-route management system is provided. The system includes a first sensor module configured to generate a signal indicative of a current position of a machine at the worksite. The system also includes a route control module configured to receive the signal indicative of the current position of the machine. The route control module receives a signal indicative of a predetermined path associated with the machine. The route control module segments a current path of the machine based on predetermined boundaries. Further, the route control module compares the segmented current path with corresponding data points on the predetermined path. The route control module determines if a deviation from the predetermined path is present in at least one portion of the current path based on the comparison. The route control module provides a notification of the deviation if the deviation lies outside of a predetermined range.

### TECHNICAL FIELD

The present disclosure relates to a worksite management system. More particularly, the present disclosure relates to a system and method for haul route management at a worksite.

### BACKGROUND

A number of machines may operate on large worksites. A foreman may need to remotely supervise and monitor a haul route for the machines. The environment in which the machines operate could be dynamic such that the haul route to be assigned to the machines may change over time. In other scenarios, the haul route may change with every load or dump cycle. In this environment, it may be cumbersome for the foreman to communicate the changes in the haul route to operators of the different machines.

Moreover, the foreman may not be able to physically monitor the haul route of the machines in all cases. The foreman may also find it difficult to supervise the haul route without any input from an operator. In case of disruption in radio communication, the foreman may be unable to inform the operator of changes in the haul route. Further, since the monitoring capabilities of the foreman may be limited, the foreman may be unaware as to whether the operator has accurately received updated information regarding the haul route and is correctly following the new haul route. The foreman may also find it tedious to constantly keep check on activities of the operator. Thus, overall efficiency and productivity may be affected leading to cost inefficiencies.

U.S. Pat. No. 8,583,361 describes a system and method for navigating a first heavy equipment to a target destination. A location of the target destination is retrieved from a distributed objects database. The location of the target destination is at least partially determined by a position of a second heavy equipment. A position sensor identifies a current position and orientation of the first heavy equipment, and a path from the current position of the first heavy equipment to the location of the target destination is calculated. The calculated path is selected to avoid hazards. A progress of the first heavy equipment along the calculated path is monitored using the position sensor. When the first heavy equipment deviates from the calculated path, a message is outputted to an operator of at least one of the first heavy equipment and the second heavy equipment.

### SUMMARY OF THE DISCLOSURE

In one aspect of the present disclosure, a haul-route management system for a machine operating at a worksite is provided. The system includes a first sensor module configured to generate a signal indicative of a current position of the machine at the worksite. The system also includes a route control module communicably coupled to the first sensor module. The route control module is configured to receive the signal indicative of the current position of the machine. The route control module is configured to receive a signal indicative of a predetermined path associated with the machine on at least one of a per cycle and a material basis. The route control module is configured to segment a current path of the machine based on predetermined boundaries. Further, the route control module is configured to compare the segmented current path with corresponding data points on the predetermined path. The route control module is configured to determine if a deviation from the predetermined path is present in at least one portion of the current path based on the comparison. The route control module is configured to provide a notification of the deviation if the deviation lies outside of a predetermined range.

In another aspect of the present disclosure, a method for haul route management for a machine operating at a worksite is provided. The method includes receiving a signal indicative of a current position of the machine at the worksite. The method includes receiving a signal indicative of a predetermined path associated with the machine on at least one of a per cycle and a material basis. The method includes segmenting a current path of the machine based on predetermined boundaries. Further, the method includes comparing the segmented current path with corresponding data points on the predetermined path. The method includes determining if a deviation from the predetermined path is present in at least one portion of the current path based on the comparison.

The method includes providing a notification of the presence of the deviation if the deviation lies outside of a predetermined range.

Other features and aspects of this disclosure will be apparent from the following description and the accompanying drawings.

### BRIEF DESCRIPTION OF THE DRAWINGS

FIG. 1 is a schematic of an exemplary worksite, according to one embodiment of the present disclosure;

FIG. 2 is a block diagram of a route management system associated with the worksite of FIG.1, according to one embodiment of the present disclosure;

FIGS. 3 to 5 are different stages in processing steps performed by the route management system of FIG. 2, according to one embodiment of the present disclosure; and

FIG. 6 is a flowchart of a method of operation of the route management system, according to one embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

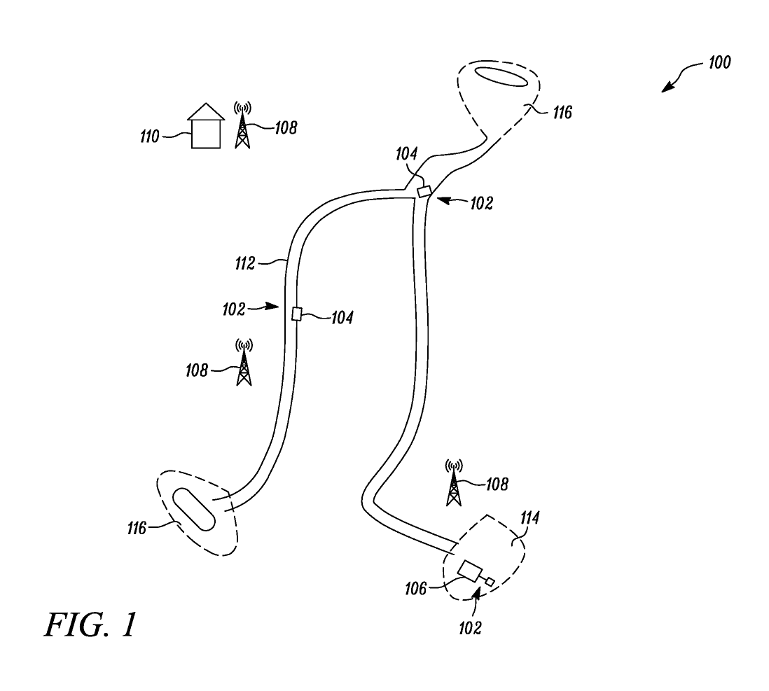

FIG. 1 shows an exemplary worksite 100. A number of different machines 102 configured for transportation of material from one location to another may be deployed on the worksite 100. The machines 102, include a hauler 104 embodied as, but not limited to, a mining truck, a haul truck, an on-highway truck, an off-highway truck, and an articulated truck. Further, a number of different loading machines 106 may also be deployed on the worksite 102. The loading machine 106 is configured to load the material on the hauler 104. The type of loading machines 106 may include, for example, a conveyor, a large wheel loader, a track-type loader, a shovel, a dragline, a crane or any other loading machine known to one skilled in the art. For the purpose of simplicity, the haulers 104 and the loading machines 106 will be collectively referred to as the machines 102 hereinafter.

In one embodiment, the machines 102 may be communicably coupled to each other via a communication system 108. In another embodiment, the machine 104 and the loading machine 106 may be communicably coupled to a remote control station 110 via the communication system 108. Typically, the remote control station 110 may be located off-worksite 102. The remote control station 110 may enable remote monitoring and/or controlling of various functions related to the operation of the loading machine 106 and/or the machine 104 deployed on the worksite 102.

The communication system 108 may be, but not limited to, a wide area network (WAN), a local area network (LAN), an Ethernet, an Internet, an Intranet, a cellular network, a satellite network, or any other suitable network for transmitting data between the machine 104, the loading machine 106 and/or the remote control station 110. In various embodiments, the communication system 108 may include a combination of two or more of the aforementioned networks and/or other types of networks known in the art. The communication system 108 may be implemented as a wired network, a wireless network or a combination thereof. Further, data transmission between the machine 104, the loading machine 106 and the remote control station 110 may occur over the communication system 108 in an encrypted, any other secure format, or in any of a wide variety of known manners. Alternatively, when external infrastructure may be absent, each of the machines 102 may have an onboard inter-communication system, for example, a WAN.

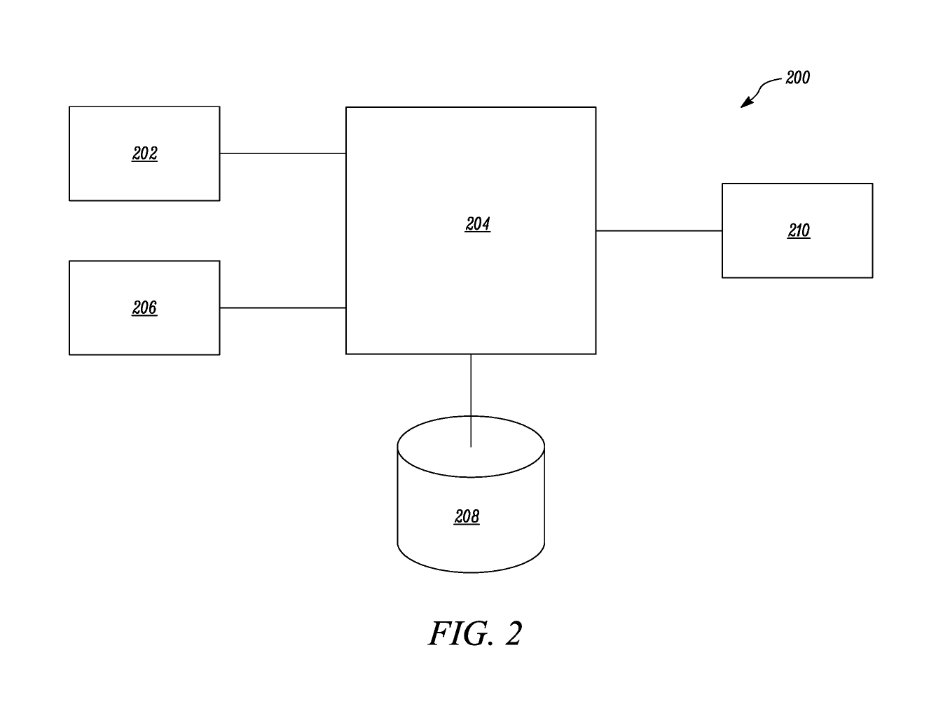

The machines 102 are assigned a haul route 112 for transporting the material from a designated load location 114 to a dump location 116. These designated haul routes 112 may vary on a per cycle basis or on the basis of a type of the material that the machine 102 is currently carrying. The present disclosure relates to a haul route management system 200 (see FIG. 2) for the worksite 100.

Referring to FIG. 2, the haul route management system 200 includes a first sensor module 202 present on the machines 102. The first sensor module 202 is configured to generate a signal indicative of a current position of the respective machine 102 at the worksite 100. The first sensor module 202 may be embodied as a Global Positioning System (GPS). Alternatively, the first sensor module 202 may include an accelerometer and/or a gyroscope. In yet another embodiment, the first sensor module 202 may include a perception based system such as a Light Detection And Ranging (LIDAR) system, a radar system, a Sound Navigation And Ranging (SONAR) system, and so on.

The haul route management system 200 further includes a route control module 204. Referring to FIGS. 1 and 2, the route control module 204 is located at the remote control station 110. The route control module 204 is communicably coupled to each of the machines 102 operating at the worksite 100 via the communication system 108. The route control module 204 is configured to receive the signal indicative of the current location of the respective machines 102. Further, the route control module 204 is configured to monitor a current path of the machine 102 based on the location of the machine 102 from the load location 114 to the dump location 116.

At a start of a work cycle, a foreman or any suitable personnel may assign or allocate a predetermined path to the material being unloaded by the machine 102. This allocation of the predetermined path may vary on a per cycle basis or on the basis of the type of the material on the machine 102. The route control module 204 is communicably coupled to an input device 206. In one embodiment, the input device 206 may be used by the foreman to input the predetermined path. The input device 206 may be a handheld or portable device such as a laptop, a tablet, a smartphone, and so on running suitable online, web, or Dedicated Short Range Communications (DSRC) applications to access the system. Also, the foreman may allocate the load location 114, the dump location 116, or both as the case may be via the input device 206. For example, the foreman may draw out the entire predetermined path that the machine 102 needs to follow for the given cycle. In another example, the foreman may select the predetermined path from a set of established paths. The predetermined path, the load and/or dump locations 114, 116 may be transmitted from the remote control station 110 to the loading machine 106 assigned to the given hauler 104 via the communication system 108, so that the assigned predetermined path, the load and/or dump locations 114, 116 may be further transmitted to the hauler 104 by the loading machine 106.

In another embodiment, the predetermined path and/or set of established paths that may be stored and retrieved from any suitable database 208, repository and/or external source. The database 208 may store previously entered predetermined paths therein. Based on selection by the foreman, each of the set of established paths may either be in an “assigned active” state or an “inactive” state to optimize the data transfer needed for the system to perform as desired. In yet another embodiment, the predetermined path may be an average path or global average path that the machines 102 have followed previously. In some cases, the average path may be followed multiple times in the past by a fleet of the machines 102. Accordingly, the system may build and store a haul site map in the database 208 based on machine learning or other known techniques for ease in assignment of previously established paths. In some embodiments, the predetermined path may be input by an operator of the machine 102 via the input device 206 for example, a touchscreen, provided within an operator cabin of the machine 102.

Further, the route control module 204 is configured to segment the current path of the machine 102 on the basis of virtual boundaries. The segmentation of the current path may involve establishing the geographical virtual boundary and sub-boundaries such that the current path has a profile. The profile of the segmented current path can be considered as time ordered coordinates with reference to the boundaries and the sub-boundaries. In a similar manner, the predetermined path is also segmented with reference to the boundaries and sub-boundaries to form corresponding data points. Further, the route control module 204 compares the segmented current path with the corresponding data points of the predetermined path to ascertain if any deviation exists in portions of the current path.

During comparison of a given profile of the segmented current path and the predetermined path, if a match is found indicating that the deviation is absent between the current path and the predetermined path, the route control module 204 aggregates the profile of the current path to compute the average path taken by the machine 102. Accordingly, the route control module 204 computes an average of the profile of the current path and the corresponding data points of the predetermined path to form the average path.

If a deviation is detected in any portion of the segmented current path and the predetermined path, the route control module 204 checks if the deviation is within or outside of an acceptable predetermined range. In one embodiment, the predetermined range may be input by the foreman via the input device 206. For example, the route control module 204 determines if the distance of the segmented current path is less than the predetermined range. If the deviation is within the predetermined range, the deviation is ignored by the route control module 204. In some embodiments, the profile of the current path may further be aggregated with the average path.

If the deviation lies outside of the predetermined range, the route control module 204 iteratively clusters the segmented current path until the next match between the segmented current path and the predetermined path is found. The route control module 204 identifies the portion of the current path that is a deviation from the predetermined path based on the clustering of the mismatched profiles.

The route control module 204 is communicably coupled to an output device 210. The route control module 204 provides a notification of the deviation via the output device 210. The output device 210 includes a screen, a monitor, or any other visual indication device present on the machine 102 or remotely located from the machine 102. In one embodiment, the route control module 204 may store a log of all the deviations on a machine basis, cycle basis, and/or a time sequencing basis in the database 208. Further, the route control module 204 may flag the deviations for the foreman to view at a later stage. In some embodiments, a real-time view of the predetermined path, the current path and any deviations, if present, may be displayed on the output device 210. Further, the route control module 204 may provide a notification by visual display of any changes in the predetermined path based on the input provided by the foreman.

In some embodiments, the route control module 204 may additionally receive other operating parameters of the machine 102 along the current path for comparison with predetermined metrics associated with the predetermined path. These operating parameters may include, but not limited to, a speed and a heading of the machine 102. In one example, the route control module 204 may determine if the speed of the machine 102 at different intervals along the current path matches with an expected predetermined metric range. If the speed does not match, the route control module 204 may provide a suitable notification of the mismatch. In yet other embodiments, if the deviation is detected between the current path and the predetermined path, the route control module may transmit commands for controlling an operation of the machine 102 so that the deviation may be corrected.

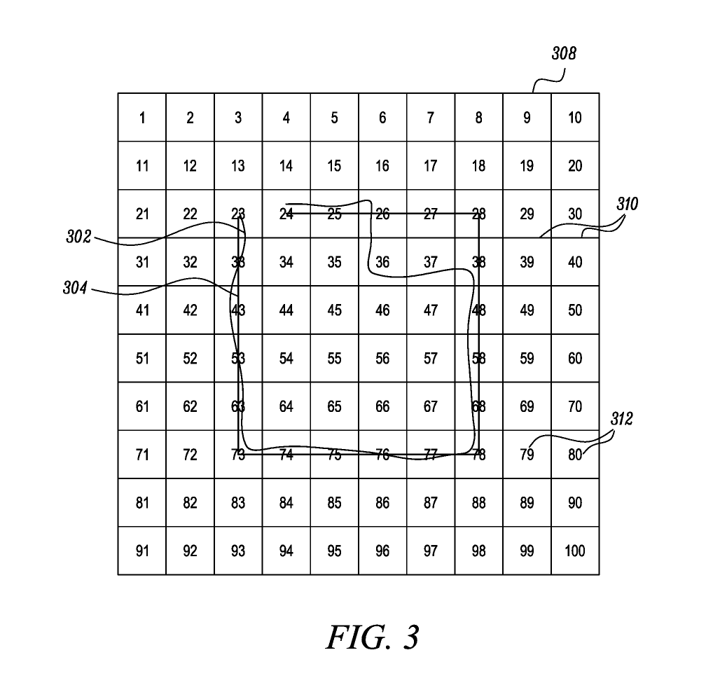

The different stages of operation of the route control module 204 will now be explained with reference to an example included for the purpose of clarity. Referring to FIG. 3, the current path of the machine 102 is depicted using line 302 and the predetermined path of the machine 102 is depicted using line 304. The boundary 308 and sub-boundaries 310 are formed to completely encompass the current path 302 and the predetermined path 304. The sub-boundaries 310 divide the boundary 308 into a virtual grid with a high enough resolution to obtain required details of route curves when noise is averaged out of the signals. Each of the sub-boundaries 310 is stored as a rectangular object with four vertices referenced as four coordinates. The current path 302 and the predetermined path 304 may be considered as collections of time-series coordinates between load-to-dump and/or dump-to-load sites respectively.

The current path 302 and the predetermined path 304 each have their own profile. Based on the sub-boundaries 310 that are defined within the boundary 308 by the route control module 204, the route control module 204 defines respective sub-boundary profiles 312 for the current path 302 and the predetermined path 304. Accordingly, the route control module 204 segments the current path 302 and the predetermined path 304 to assign the sub-boundary profile 312 to the current path 302 and the predetermined path 304 respectively. The sub-boundary profile 312 may eliminate having to iterate through unnecessary sub-boundaries 310 facilitating easier comparison of the current path 302 and the predetermined path 304. The sub-boundary profiles 312 are time-series ordered. The route control module 204 assigns the sub-boundary profile 312 to the current path 302 and/or the predetermined path 304 when a coordinate from that the respective current path 302 and/or predetermined path 304 falls within that sub-boundary 310.

The route control module 204 assigns the following sub-boundary profile 312 to the predetermined path 304 and the current path 302 respectively:
Sub-boundary profile of predetermined path:
23,33,43,53,63,73,74,75,76,77,78,68,58,48,38,28,27,26,25,24,23
Sub-boundary profile of current path: 23,33,43,53,63,73,74,75,76,77,78,68,58,48,38,37,36,26,25,24,23
   Further, after assigning the sub-boundary profiles 312 to the current path 302 and the predetermined path 304, the route control module 204 compares the current path 302 with the predetermined path 304.

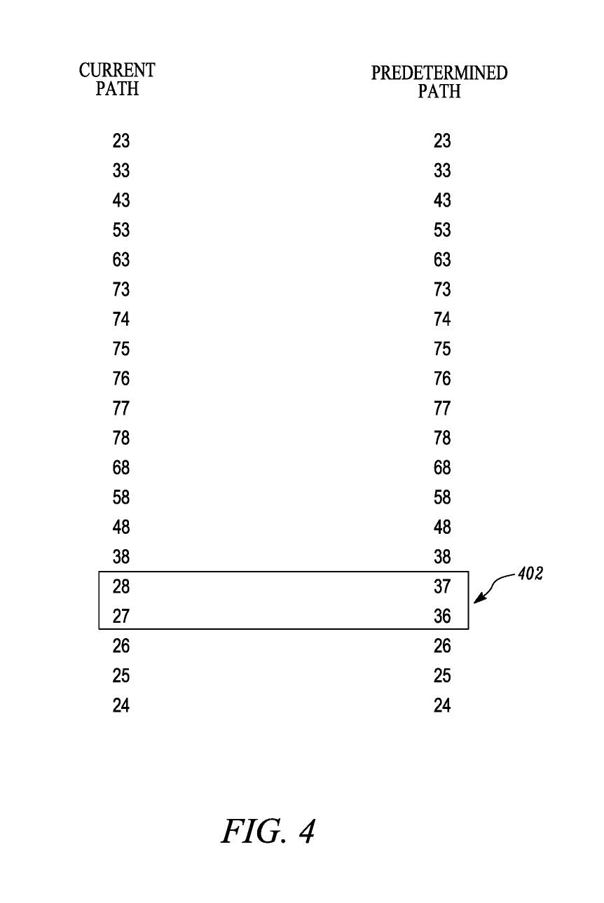

Referring to FIG. 4, the route control module 204 iteratively compares the profile of the current path 302 with that of the predetermined path 304. The route control module 204 starts by comparing current path sub-boundary profile #23 and looks for a matching predetermined path sub-boundary profile #23. Since the match is found, the route control module 204 iterates to the predetermined path sub-boundary profile #33 and looks for a match in a similar manner. Further, the route control module 204 computes the average route by aggregating the segmented current path with the average path.

When the route control module 204 reaches section 402, the route control module 204 checks if current path sub-boundary profile #28 matches with the predetermined path sub-boundary profile #37. The route control module 204 determines a mismatch between the sub-boundary profile 312 of the current path 302 and the predetermined path 304. Hence, the route control module 204 further checks if the detected deviation lies within the predetermined range or not. In this case, the deviation does not lie within the predetermined range, and hence the route control module 204 flags the deviation for further notification to the foreman. Accordingly, the route control module 204 opens a first deviation path segment.

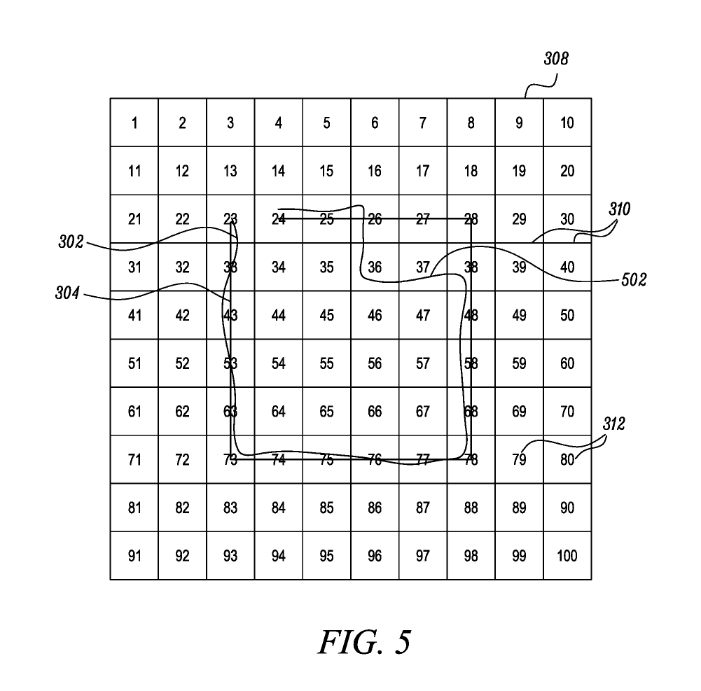

Similarly, the route control module 204 determines that the current path sub-boundary profile #27 does not match with the predetermined path sub-boundary profile #36. Again, the route control module 204 checks if the deviation lies within the predetermined range. In this case, the deviation does not lie within the predetermined range, and is hence flagged by the system. Further, the route control module 204 checks for any open deviation paths and aggregates the current deviation with the first deviation path segment. During the next comparison, the route control module 204 finds a match between the current path sub-boundary profile #26 and the predetermined path sub-boundary profile #26. Accordingly, the first deviation path segment is then closed by the route control module 204. Referring to FIG. 5, the route control module 204 may display the current path 302, the predetermined path 304, and the first deviation path segment 502 on the output device 210.

The operational steps provided herein are exemplary and do not limit the scope of the present disclosure. Further, the values and use case that is described is merely on an illustrative basis and may vary based on the system and application. The processing complexity, manner and order of carrying out the algorithmic steps may vary based on the implementation requirements.

A person of ordinary skill in the art will appreciate that the route control module 204 may additionally include other components not described herein. Moreover, the functionality of the route control module 204 explained above is exemplary and does not limit the scope of the disclosure. The route control module 204 may additionally perform other functions. Similar to the route control module 204 may additionally contain a processing unit embodied as a single microprocessor or multiple microprocessors. Numerous commercially available microprocessors may be configured to perform the functions of the route control module 204, and it should be appreciated that the route control module 204 may readily embody a general machine microprocessor capable of monitoring and/or controlling numerous machine functions.

### INDUSTRIAL APPLICABILITY

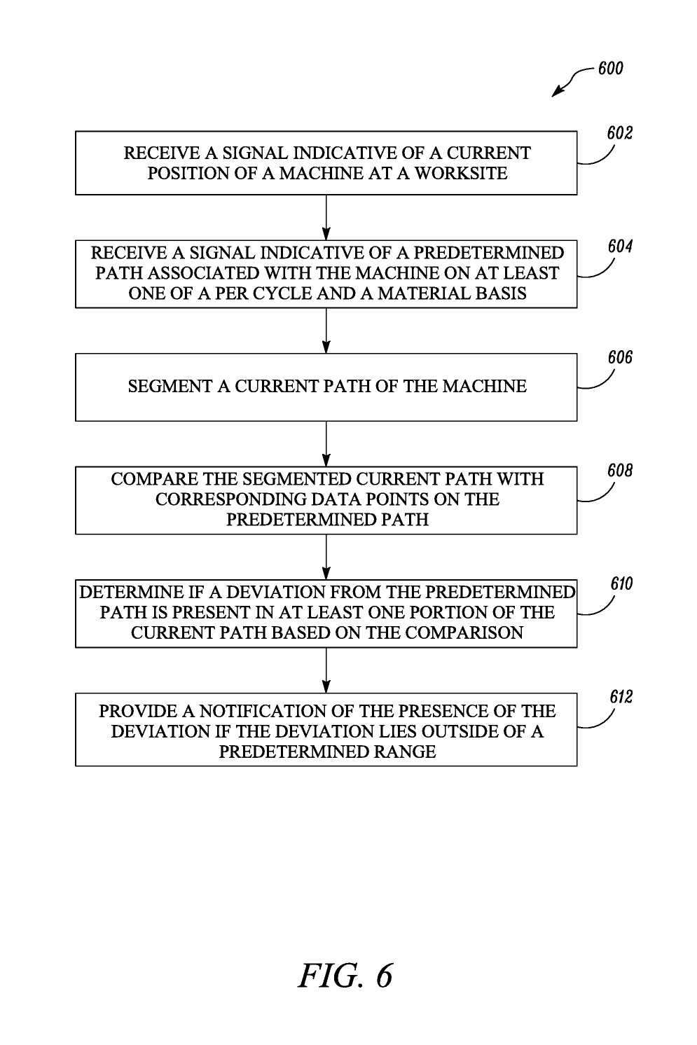

The present disclosure relates to the haul route management system 200. FIG. 6 is a method 600 of operation of the haul route management system 200. At step 602, the route control module 204 receives the signal indicative of the current position of the machine 102 at the worksite 100. At step 604, the route control module 204 receives the signal indicative of the predetermined path associated with the machine 102. At step 606, the route control module 204 segments the current path of the machine 102. At step 608, the route control module 204 compares the segmented current path with corresponding data points on the predetermined path. At step 610, the route control module 204 determines if the deviation from the predetermined path is present in at least one portion of the current path based on the comparison. At step 612, the route control module 204 provides the notification of the presence of the deviation if the deviation lies outside of the predetermined range.

The system provides a simple and user friendly solution to dynamically monitor operation of the machines 102 in a real-time environment. The system can be used with ease for rapidly changing layouts of the worksite 100 that may change on a day-to-day on intra-day basis. The system may account for increased complexity on the worksite 100. On a macro-level, the system can take into account the average path, which may either be provided by the foreman or established after the machine 102 has taken the given path over a set number of times. Accordingly, the comparison with the predetermined path may be used to build up confidence in the route that the system has set or computed. For example, for the machines 102 that get loaded or dump at consistent locations over time, the predetermined path may be chosen from the previous paths that the machine 102 has followed.

On a micro-level, the foreman may be able to pass the predetermined path on the per cycle or the material basis to the machine 102. This may account for increased complexity faced with establishing the predetermined path when the load and dump locations 114, 116 and/or material types change frequently. For example, the machine 102 gets loaded at one spot and dumps in a particular spot. However, in the next cycle the machine 102 gets loaded at a different spot or with different material, and dumps in the same or different dump spot. Thus, as complexity is increased, each of the machines 102 may have intersecting haul routes when the load and dump locations 114, 116 change drastically.

Further, the system can be used in material tracking applications. After the predetermined path is entered into the system, the system can perform analysis on the validity of the predetermined path and notify if the predetermined path is changing over time. Also, the system may verify if roads associated with the predetermined path were built as designed. For example, the personnel responsible for creating and managing haul roads at the worksite 100 may create a new predetermined path using one of the predefined methods. After loading of the predetermined path into the system, the system can be used to track changes over time or alert the foreman of changes in the predetermined path. In some cases, this data may be sent directly to support equipment to address any road maintenance needs.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A haul-route management system for a machine operating at a worksite, the system comprising:
a first sensor module configured to generate a signal indicative of a current position of the machine at the worksite; and
a route control module communicably coupled to the first sensor module, the route control module configured to:
receive the signal indicative of the current position of the machine;
receive a signal indicative of a predetermined path associated with the machine on at least one of a per cycle and a material basis;
segment a current path of the machine based, at least in part, on predetermined boundaries;
compare the segmented current path with corresponding data points on the predetermined path;
determine if a deviation from the predetermined path is present in at least one portion of the current path based on the comparison; and
provide a notification of the deviation if the deviation lies outside of a predetermined range.

2. The system of claim 1, wherein the first sensor module is at least one of a global positioning system, an accelerometer, and a gyroscope.

3. The system of claim 1, wherein the route control module is further configured to receive a signal indicative of at least one of a speed and a heading of the machine.

4. The system of claim 1, wherein the route control module is further configured to control an operation of the machine if the deviation is present.

5. The system of claim 1, wherein the route control module is further configured to receive the predetermined path via an input device, wherein the predetermined path is at least one of provided by a user and selected from a set of established routes.

6. The system of claim 1, wherein the route control module is further configured to assign any one of a load and a dump location to the machine via the input device.

7. The system of claim 1, wherein the route control module is further configured to estimate the predetermined path based, at least in part, on a previous path of the machine and an average path taken by a fleet of the machines.

8. The system of claim 1, wherein the route control module is further configured to:
cluster the segmented current path until the segmented current path matches with the predetermined path if the deviation is present; and
identify the at least one portion of the segmented current path that deviates from the predetermined path based on the clustering.

9. The system of claim 1, wherein the route control module is configured to compute an average path of corresponding current positions of the current path and the data points of the predetermined path if the deviation is ab sent.

10. The system of claim 1, wherein the route control module is further configured to provide a notification of a change in the predetermined path.

11. The system of claim 1, wherein the predetermined range is input by a user.

12. A method for haul route management for a machine operating at a worksite, the method comprising:
receiving a signal indicative of a current position of the machine at the worksite;
receiving a signal indicative of a predetermined path associated with the machine on at least one of a per cycle and a material basis;
segmenting a current path of the machine based, at least in part, on predetermined boundaries;
comparing the segmented current path with corresponding data points on the predetermined path;
determining if a deviation from the predetermined path is present in at least one portion of the current path based on the comparison; and
providing a notification of the presence of the deviation if the deviation lies outside of a predetermined range.

13. The method of claim 12 further including:
receiving a signal indicative of at least one of a speed and a heading of the machine.

14. The method of claim 12 further including:
controlling an operation of the machine if the deviation is present.

15. The method of claim 12 further including:
receiving the predetermined path via an input device, wherein the predetermined path is at least one of provided by a user and selected from a set of established routes.

16. The method of claim 12 further including:
assigning any one of a load and a dump location to the machine via the input device.

17. The method of claim 12 further including:
estimating the predetermined path based, at least in part, on a previous path of the machine and an average path taken by a fleet of the machines.

18. The method of claim 12 further including:
clustering segmented current path until the segmented current path matches with the predetermined path if the deviation is present; and
identifying the at least one portion of the segmented current path that deviates from the predetermined path based on the clustering.

19. The method of claim 12 further including:
computing an average path of corresponding current positions of the current path and the data points of the predetermined path if the deviation is absent.

20. The method of claim 12 further including:
providing a notification of a change in the predetermined path.
